(19) United States
(12) Patent Application Publication
(10) Pub. No.: US 2009/0317725 A1
(43) Pub. Date: Dec. 24, 2009

(54) Lithium cell with cathode containing iron disulfide

(76) Inventors: Zhiping Jiang, Westford, MA (US); Leigh Friguglietti, Westfield, MA (US); Thomas N. Koulouris, Belmont, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/214,825

(22) Filed: Jun. 23, 2008

(51) Int. Cl. H01M 6/16; H01M 4/58

(52) U.S. Cl. 429/326; 429/221; 429/231.95

(57) ABSTRACT

A primary cell having an anode comprising lithium and a cathode comprising iron disulfide (FeS₂) and carbon particles. The electrolyte comprises a lithium salt dissolved in a solvent mixture which contains 1,3-dioxolane and preferably 1,3-dimethyl-2-imidazolidinone. A cathode slurry is prepared comprising iron disulfide powder, carbon, binder, and a liquid solvent. The mixture is coated onto a conductive substrate and solvent evaporated leaving a dry cathode coating on the substrate. The anode and cathode can be spirally wound with separator therebetween and inserted into the cell casing with electrolyte then added.

### FIELD OF THE INVENTION

The invention relates to lithium cells having an anode comprising lithium and a cathode comprising iron disulfide and an electrolyte comprising a lithium salt, preferably lithium iodide and solvent which includes 1,3-dioxolane and 1,3-dimethyl-2-imidazolidinone.

### BACKGROUND

Primary (non-rechargeable) electrochemical cells having an anode of lithium are known and are in widespread commercial use. The anode is comprised essentially of lithium metal. Such cells typically have a cathode comprising manganese dioxide, and electrolyte comprising a lithium salt such as lithium trifluoromethane sulfonate (LiCF₃SO₃) dissolved in an organic solvent. The cells are referenced in the art as primary lithium cells (primary Li/MnO₂ cells) and are generally not intended to be rechargeable. Alternative, primary lithium cells with lithium metal anodes but having different cathodes, are also known. Such cells, for example, have cathodes comprising iron disulfide (FeS₂) and are designated Li/FeS₂ cells. The iron disulfide (FeS₂) is also known as pyrite. The Li/MnO₂ cells or Li/FeS₂ cells are typically in the form of cylindrical cells, typically AA size or AAA size cells, but may be in other size cylindrical cells. The Li/MnO₂ cells have a voltage of about 3.0 volts which is twice that of conventional Zn/MnO₂ alkaline cells and also have higher energy density (watt-hrs per cm³ of cell volume) than that of alkaline cells. The Li/FeS₂ cells have a voltage (fresh) of between about 1.2 and 1.8 volts which is about the same as a conventional Zn/MnO₂ alkaline cell. However, the energy density (watt-hrs per cm³ of cell volume) of the Li/FeS₂ cell is higher than a comparable size Zn/MnO₂ alkaline cell. The theoretical specific capacity of lithium metal is high at 3861.4 mAmp-hr/gram and the theoretical specific capacity of FeS₂ is 893.6 mAmp-hr/gram, and the theoretical capacity of. The FeS₂ theoretical capacity is based on a 4 electron transfer from 4Li per FeS₂ molecule to result in reaction product of elemental iron Fe and 2Li₂S. That is, 2 of the 4 electrons change the oxidation state of +2 for Fe⁺² in FeS₂ to 0 in elemental iron (Fe⁰) and the remaining 2 electrons change the oxidation state of sulfur from −1 in FeS₂ to −2 in Li₂S.

Overall the Li/FeS₂ cell is much more powerful than the same size Zn/MnO₂ alkaline cell. That is for a given continuous current drain, particularly at higher current drain over 200 milliAmp, the voltage is flatter for longer periods for the Li/FeS₂ cell than the Zn/MnO₂ alkaline cell as may be evident in a voltage vs. time discharge profile. This results in a higher energy output obtainable from a Li/FeS₂ cell compared to that obtainable for a same size alkaline cell. The higher energy output of the Li/FeS₂ cell is more clearly and more directly shown in graphical plots of energy (Watt-hrs) versus continuous discharge at constant power (Watts) wherein fresh cells are discharged to completion at fixed continuous power outputs ranging from as little as 0.01 Watt to 5 Watt. In such tests the power drain is maintained at a constant continuous power output selected between 0.01 Watt and 5 Watt. (As the cell's voltage drops during discharge the load resistance is gradually decreased raising the current drain to maintain a fixed constant power output.) The graphical plot Energy (Watt-Hrs) versus Power Output (Watt) for the Li/FeS₂ cell is above that for the same size alkaline cell. This is despite that the starting voltage of both cells (fresh) is about the same, namely, between about 1.2 and 1.8 volt.

Thus, the Li/FeS₂ cell has the advantage over same size alkaline cells, for example, AAA, AA, C or D size or any other size cell in that the Li/FeS₂ cell may be used interchangeably with the conventional Zn/MnO₂ alkaline cell and will have greater service life, particularly for higher power demands. Similarly the Li/FeS₂ cell which is a primary (nonrechargeable) cell can also be used as a replacement for the same size rechargeable nickel metal hydride cell, which has about the same voltage (fresh) as the Li/FeS₂ cell. Thus, the primary Li/FeS₂ cell can be used to power digital cameras, which require operation at high pulsed power demands.

The cathode material for the Li/FeS₂ cell may be initially prepared in a form such as a slurry mixture (cathode slurry), which can be readily coated onto the metal substrate by conventional coating methods. The electrolyte added to the cell must be a suitable organic electrolyte for the Li/FeS₂ system allowing the necessary electrochemical reactions to occur efficiently over the range of high power output desired. The electrolyte must exhibit good ionic conductivity and also be sufficiently stable, that is non reactive, with the undischarged electrode materials (anode and cathode components) and also non-reactive with the discharge products. This is because undesirable oxidation/reduction reactions between the electrolyte and electrode materials (either discharged or undischarged) could thereby gradually contaminate the electrolyte and reduce its effectiveness or result in excessive gassing. This in turn can result in a catastrophic cell failure. Thus, the electrolyte used in Li/FeS₂ cell in addition to promoting the necessary electrochemical reactions, should also be stable to discharged and undischarged electrode materials. Additionally, the electrolyte should enable good ionic mobility and transport of the lithium ion (Li⁺) from anode to cathode so that it can engage in the necessary reduction reaction resulting in LiS₂ product in the cathode.

An electrode composite is formed with a sheet of lithium, a sheet of cathode composite containing the FeS₂ active material and separator therebetween. The electrode composite may be spirally wound and inserted into the cell casing, for examples, as shown in U.S. Pat. No. 4,707,421. A cathode coating mixture for the Li/FeS₂ cell is described in U.S. Pat. No. 6,849,360. A portion of the anode sheet is typically electrically connected to the cell casing which forms the cell's negative terminal. The cell is closed with an end cap which is insulated from the casing. The cathode sheet can be electrically connected to the end cap which forms the cell's positive terminal. The casing is typically crimped over the peripheral edge of the end cap to seal the casing's open end. The cell may be fitted internally with a PTC (positive thermal coefficient) device or the like to shut down the cell in case the cell is exposed to abusive conditions such as short circuit discharge or overheating.

The electrolyte used in a primary Li/FeS₂ cells are formed of a “lithium salt” dissolved in an “organic solvent”. Representative lithium salts which may be used in electrolytes for Li/FeS₂ primary cells are referenced in U.S. Pat. No. 5,290,414 and U.S. Pat. No. 6,849,360 B2 and include such salts as: Lithium trifluoromethanesulfonate, LiCF₃SO₃ (LiTFS); lithium bistrifluoromethylsulfonyl imide, Li(CF₃SO₂)₂N (LiTFSI); lithium iodide, LiI; lithium bromide, LiBr; lithium tetrafluoroborate, LiBF₄; lithium hexafluorophosphate, LiPF₆; lithium hexafluoroarsenate, LiAsF₆; Li(CF₃SO₂)₃C, and various mixtures. In the art of Li/FeS₂ electrochemistry lithium salts are not always interchangeable as specific salts work best with specific electrolyte solvent mixtures.

In U.S. Pat. No. 5,290,414 (Marple) is reported use of a beneficial electrolyte for FeS₂ cells, wherein the electrolyte comprises a lithium salt dissolved in a solvent comprising 1,3-dioxolane (DX) in admixture with a second solvent which is an acyclic (non cyclic) ether based solvent. The acyclic (non cyclic) ether based solvent as referenced may be dimethoxyethane (DME), ethyl glyme, diglyme and triglyme, with the preferred being 1,2-dimethoxyethane (DME). As given in the example the dioxolane and 1,2-dimethoxyethane (DME) are present in the electrolyte in substantial amount, i.e., 50 vol % 1,3-dioxolane (DX) and 40 vol % dimethoxyethane (DME) or 25 vol % 1,3-dioxolane (DX) and 75 vol.% dimethoxyethane (DME)(col. 7, lines 47-54). A specific lithium salt ionizable in such solvent mixture(s), as given in the example, is lithium trifluoromethane sulfonate, LiCF₃SO₃. Another lithium salt, namely lithium bistrifluoromethylsulfonyl imide, Li(CF₃SO₂)₂N is also mentioned at col. 7, line 18-19. The reference teaches that a third solvent may optionally be added selected from 3,5-dimethylisoxazole (DMI), 3-methyl-2-oxazolidone, propylene carbonate (PC), ethylene carbonate (EC), butylene carbonate (BC), tetrahydrofuran (THF), diethyl carbonate (DEC), ethylene glycol sulfite (EGS), dioxane, dimethyl sulfate (DMS), and sulfolane (claim 19), with the preferred being 3,5-dimethylisoxazole.

In U.S. Pat. No. 6,218,054 (Webber) is disclosed an electrolyte solvent system wherein dioxolane-based solvent and dimethoxyethane-based solvent are present in a weight ratio of about 1:3 (1 part by weight dioxolane to 3 parts by weight dimethoxyethane).

In U.S. Pat. No. 6,849,360 B2 (Marple) is disclosed an electrolyte for an Li/FeS₂ cell, wherein the electrolyte comprises the salt lithium iodide dissolved in the organic solvent mixture comprising 1,3-dioxolane (DX), 1,2-dimethoxyethane (DME), and small amount of 3,5 dimethylisoxazole (DMI). (col. 6, lines 44-48.)

In US 2007/0202409 A1 (Yamakawa) it is stated with reference to the electrolyte solvent for the Li/FeS₂ cell at para. 33: “Examples of the organic solvent include propylene carbonate, ethylene carbonate, 1,2-dimethoxy ethane, γ-butyrolactone, tetrahydrofuran, 2-methyltetrahydrofuran, 1,3-dioxolane, sulfolane, acetonitrile, dimethyl carbonate, and dipropyl carbonate, and any one of them or two or more of them can be used independently, or in a form of a mixed solvent.” Such statement is misleading, since the art teaches only specific combinations of electrolyte solvents will be workable for the Li/FeS₂ cell depending on the particular lithium salt to be dissolved in the solvent. (See, e.g. above U.S. Pat. No. 5,290,414 and U.S. Pat. No. 6,849,360) The reference Yamakawa does not teach which combination of solvents from the above list are to be used with any given lithium salt.

In U.S. 2006/0046152 (Webber) is disclosed an electrolyte system for a lithium cell which may have a cathode comprising FeS₂ and FeS therein. The disclosed electrolyte contains lithium iodide salt dissolved in a solvent system comprising a mixture of 1,2-dimethoxypropane and 1,2-dimethoxyethane.

The choice of a particular organic solvent or mixture of different organic solvents for use in conjunction with any one or more lithium salts to produce a suitable electrolyte for the Li/FeS₂ cell is challenging. This is not to say that many combinations of lithium salts and organic solvents do not produce a Li/FeS₂ cell which will not work at all. But rather the challenge associated with such cells using an electrolyte formed with just any combination of known lithium salt and organic solvent is that the problems encountered will likely be very substantial, thus making the cell impractical for commercial usage. The history of development of lithium cells in general, whether lithium primary cells, e.g. non rechargeable Li/MnO₂ or Li/FeS₂ cells or rechargeable lithium or lithium ion cells reveals that just any combination of lithium salt and organic solvent cannot be expected to result in a good cell, that is, exhibiting good, reliable performance. Thus, references which merely provide long lists of possible organic solvents for Li/FeS₂ cells do not necessarily teach combinations of solvents or combination of specific lithium salts in specific solvent mixtures, which exhibit particular or unexpected benefit.

Accordingly, it is desired to produce a Li/FeS₂ cell employing an effective electrolyte therein which promotes ionization of the lithium salt in the electrolyte and is sufficiently stable that it does not degrade with time and does not degrade the anode or cathode components.

It is desired that the electrolyte comprising a lithium salt dissolved in an organic solvent provide for good ionic mobility of the lithium ions through the electrolyte so that the lithium ions may pass at good transport rate from anode to cathode through the separator.

It is desired to produce a primary (nonrechargeable) Li/FeS₂ cell having good rate capability that the cell may be used in place of rechargeable batteries to power digital cameras.

### SUMMARY OF THE INVENTION

The invention is directed to lithium primary cells wherein the anode comprises lithium metal. The lithium may be alloyed with small amounts of other metal, for example aluminum, which typically comprises less than about 1 or 2 wt. % of the lithium alloy. The lithium which forms the anode active material, is preferably in the form of a thin foil. The cell has a cathode comprising the cathode active material iron disulfide (FeS₂), commonly known as “pyrite”. The cell may be in the form of a button (coin) cell or flat cell. Desirably the cell may be in the form of a spirally wound cell comprising an anode sheet and a cathode composite sheet spirally wound with separator therebetween. The cathode sheet is produced using a slurry process to coat a cathode mixture comprising iron disulfide (FeS₂) particles onto a conductive surface which can be a conductive metal substrate. The FeS₂ particles are bound to the conductive substrate using desirably an elastomeric, preferably, a styrene-ethylene/butylene-styrene (SEBS) block copolymer such as KRATON G1651 elastomer (Kraton Polymers, Houston, Tex.). This polymer is a film-former, and possesses good affinity and cohesive properties for the FeS₂ particles as well as for conductive carbon particle additives in the cathode mixture.

In an aspect of the invention the cathode is formed of a cathode slurry comprising iron disulfide (FeS₂) powder, conductive carbon particles, binder material, and solvent. (The term “slurry” as used herein will have its ordinary dictionary meaning and thus be understood to mean a dispersion or suspension of solid particles in liquid.) The wet cathode slurry is coated onto a conductive substrate such as a sheet of aluminum or stainless steel. The conductive substrate functions as a cathode current collector. The solvent is then evaporated leaving dry cathode coating mixture comprising the iron disulfide material and carbon particles preferably including carbon black adhesively bound to each other and with the dry coating bound to the conductive substrate. The preferred carbon black is acetylene black. The carbon may optionally include graphite particles blended therein.

After the wet cathode slurry is coated onto the conductive substrate, the coated substrate is placed in an oven and heated at elevated temperatures until the solvent evaporates. The resulting product is a dry cathode coating comprising iron disulfide and carbon particles bound to the conductive substrate. On a dry basis, the cathode preferably contains between 83 and 94 percent, desirably between about 83 and 93 percent, preferably between about 85 and 92 percent by weight FeS₂ or (FeS₂ plus FeS) cathode active material. The solids content, that is, the FeS₂ particles and conductive carbon particles in the wet cathode slurry is between 55 and 75 percent by weight. The viscosity range for the cathode slurry is typically from about 3500 to 15000 centipoise. (1 centipoise=1 mPas=1 mNewton×sec/m²). After the anode comprising lithium metal and cathode comprising iron disulfide, with separator therebetween, are inserted into the cell housing, an electrolyte is added to the cell.

In a principal aspect of the invention the desired electrolyte for the lithium/iron disulfide cell comprises a lithium salt dissolved in an organic solvent. The lithium salt preferably comprises lithium iodide (LiI). However, the lithium salt may include lithium trifluoromethane sulfonate, LiCF₃SO₃ (LiTFS) or lithium bistrifluoromethylsulfonyl imide, Li (CF₃SO₂) ₂N (LiTFSI) or mixtures of these two salts. The preferred organic solvent of the electrolyte of the invention comprises a mixture of 1,3-dioxolane (DX) and 1,3-dimethyl-2-imidazolidinone (DID). A very desirably electrolyte mixture of the invention for the lithium/iron disulfide cell has been determined to be a blend comprising lithium iodide (LiI) dissolved in a mixture of 1,3-dioxolane (DX) and 1,3-dimethyl-2-imidazolidinone (DID), wherein the 1,3-dioxolane (DX) comprises between about 70 and 90 percent by volume and the l,3-dimethyl-2-imidazolidinone (DID) comprises between about 10 and 30 percent by volume of the solvent mixture. The lithium iodide is dissolved in the solvent mixture forming the electrolyte. The lithium iodide desirably is present in said solvent mixture in a concentration of between about 0.5 and 1.2 mols per liter of solvent mixture, preferably at about 0.8 mols per liter.

1,3-dioxolane (DX) is a cyclic diether, also classified as a heterocyclic acetal. It has a Chemical Abstracts Service Registry No. (CAS) 646-06-0. It has the chemical formula C₃H₆O₂ (M.W. 74.08) and the structural formula (I):

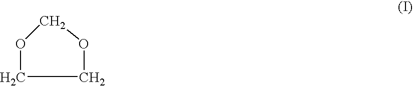

1,3-dimethyl-2-imidazolidinone (DID) is an alkyl substituted cyclic imidazolidinone. It has a Chemical Abstracts Service Registry No. (CAS) 80-73-9. It has the chemical formula C₅H₁₀N₂O (M.W. 114.15) and the structural formula (II):

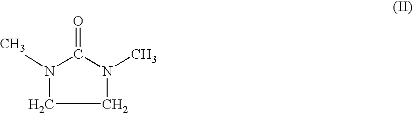

Thus, the preferred electrolyte comprises lithium iodide dissolved in an electrolyte solvent mixture comprising 1,3-dioxolane (DX) and 1,3-dimethyl-2-imidazolidinone (DID) as above indicated. Another preferred electrolyte could comprise lithium iodide dissolved in an electrolyte solvent mixture comprising 1,3-dioxolane (DX) and 1,3-diethyl-2-imidazolidinone. Yet another preferred electrolyte could comprise lithium iodide dissolved in an electrolyte solvent mixture comprising 1,3-dioxolane (DX) and 1,3-dipropyl-2-imidazolidinone. In addition, a solvent additive (third solvent) may be added in small amount to the preferred electrolytes in order to retard the rate of polymerization of the 1,3-dioxolane. The solvent additive may be selected from pyridine, an alkylisoxazole, such as 3,5-dimethylisoxazole (DMI) (C₅H₇NO), an alkylpryrazole, preferably 1,3,5-trimethylpyrazole (TMP) (C₆H₁₀N₂) or an alkylimidazole, preferably 1,2-dimethyimidazole (DI) (C₅H₈N₂). Such solvent additive to the electrolyte for the Li/FeS₂ cell in addition to retarding the rate of dioxolane polymerization, also appears to retard the rate of buildup of a deleterious passivation layer on the surface of the lithium anode. The solvent additive may comprise between about 0.2 and 5.0 percent by volume, typically between about 0.2 and 1.0 percent by volume of the total solvent mixture. The alkylpryrazole (1,3,5-trimethylpyrozole) and alkylimidazole (1,2-dimethylimidazole) are also described in commonly assigned copending patent application U.S. Ser. No. 12/070,924 filed Feb. 22, 2008.

1,3,5-trimethylpyrozole is a cyclic compound having the molecular formula C₆H₁₀N₂. It has a Chemical Abstracts Service Registry No. (CAS) 1072-91-9. The structural formula is represented as follows:

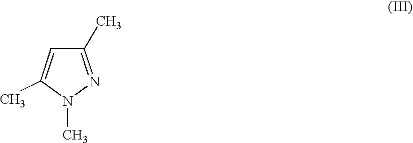

1,2-dimethylimidazole is a cyclic compound having the molecular formula C₅H₈N₂. (Abstracts Registry CAS No. 1739-84-0) The structural formula is represented as follows:

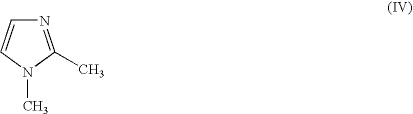

The electrolyte solvent mixture of the invention may be free of acyclic (non-cyclic) ethers such as dimethoxyethane (DME), ethyl glyme, diglyme and triglyme. The electrolyte solvent mixture of the invention may be essentially free of any other acyclic (non-cyclic) ether as well. That is, the electrolyte solvent mixture of the invention may contain only trace amounts of the acyclic (non-cyclic) ethers, e.g. total acyclic ethers comprising less than 200 ppm of the solvent mixture, e.g. less than 100 ppm dimethoxyethane (DME), e.g. less than 50 ppm of the solvent mixture. At such low concentrations (and even at somewhat higher amount) such trace amounts of the acyclic ethers would not be expected to serve any particular or substantive function. Thus, the term electrolyte solvent mixture being “essentially free” of acyclic (non-cyclic) ethers as used herein shall be understood to refer to such trace amount of acyclic (non-cyclic) ethers which may be present in the electrolyte solvent, but are present in such small (trace) amounts that they serve no particular or substantive function.

The electrolyte mixture of the invention provides the electrochemical properties needed to allow efficient electrochemical discharge of the Li/FeS₂ cell. In particular the electrolyte mixture of the invention provides the electrochemical properties needed to allow even high rate pulsed discharge demands of high power electronic devices such as digital cameras. Thus, an Li/FeS₂ cell can be produced using the electrolyte mixture of the invention resulting as a suitable primary cell for use in a digital camera normally powered by rechargeable cell. Aside from exhibiting very good electrochemical properties which allows efficient discharge of the Li/FeS₂ cell, the electrolyte solvent mixture of the invention has the advantage of having relatively low viscosity.

Applicants herein have determined that in a Li/FeS₂ cell it is advantageous to have an electrolyte of low viscosity, between about 0.9 and 1.4 centipoise. The electrolyte of the invention comprising lithium iodide salt dissolved in a solvent mixture comprising 1,3-dioxolane (DX) and 1,3-dimethy-2-imidazolidinone (DID) has low viscosity between about 0.9 and 1.4 centipoise, typically between about 1.2 and 1.4 centipoise. Such low viscosity level helps to improve Li/FeS₂ cell performance, because it promotes good lithium ion (Li⁺) transport between anode and cathode.

In order for the Li/FeS₂ cell to discharge properly lithium ions from the anode must have enough ionic mobility enabling good transport across the separator and into the FeS₂ cathode. At the cathode the lithium ions participate in the reduction reaction of sulfur ions producing LiS₂ at the cathode. Electrolytes of low viscosity are highly desirable for the Li/FeS₂ cell because 1) that it reduces lithium ion (Li⁺) concentration polarization within the electrolyte and 2) it promotes good lithium ion (Li⁺) transport mobility during discharge. In particular the low viscosity electrolyte for the Li/FeS₂ cell reduces lithium ion concentration polarization and promotes better lithium ion transport from anode to cathode when the cell is discharged at high pulsed rate, for example, when the Li/FeS₂ cell is used to power a digital camera. Lithium ion concentration polarization is reflected by the concentration gradient present between the Li anode and the FeS₂ cathode as the lithium ion transports from anode to cathode. A low viscosity electrolyte for the Li/FeS₂ cell reduces the lithium ion concentration buildup at the anode improving the lithium ion (Li⁺) mobility and in turn improving cell performance.

The electrolyte of the invention comprising lithium iodide salt dissolved in a solvent mixture comprising 1,3-dioxolane (DX) and 1,3-dimethy-2-imidazolidinone (DID) has the added advantage that it exhibits very good ionic conductivity, between about 8 and 11 S/cm (Siemens per centimeter), without causing any significant cell gassing. (1 S/cm=1/p, wherein p is resistivity, ohm×cm.) The Li/FeS₂ cell employing the electrolyte of the invention does not exhibit any significant cell gassing even when the cell is discharged under high power demands, for example, as required in digital cameras.

The electrolyte solvent mixture of the invention comprising 1,3-dioxolane (DX) and 1,3-dimethy-2-imidazolidinone (DID) has an advantage that it permits the use of lithium iodide salt in place of lithium salts such as lithium bistrifluoromethylsulfonyl imide, Li(CF₃SO₂)₂N (LiTFSI), which is an effective lithium salt, but is far more expensive than lithium iodide.

The electrolyte mixture of the invention may be beneficially employed in a coin (button) cell or wound cell for the Li/FeS₂ cell system.

### BRIEF DESCRIPTION OF THE DRAWINGS

FIG. 1A is a cross sectional view of an improved Li/FeS₂ cell of the invention as presented in a button cell embodiment.

FIG. 1B is a plan view of a spacer disk for insertion into the cell of FIG. 1A.

FIG. 1C is plan view of a spring ring for insertion into the cell of FIG. 1A.

FIG. 1D is a cross sectional view of the spring ring of FIG. 1C.

FIG. 1 is a pictorial view of an improved Li/FeS₂ cell of the invention as presented in a cylindrical cell embodiment.

FIG. 2 is a partial cross sectional elevation view of the cell taken through sight lines 2-2 of FIG. 1 to show the top and interior portion of the cell.

FIG. 3 is a partial cross sectional elevation view of the cell taken through sight lines 2-2 of FIG. 1 to show a spirally wound electrode assembly.

FIG. 4 is a schematic showing the placement of the layers comprising the electrode assembly.

FIG. 5 is a plan view of the electrode assembly of FIG. 4 with each of the layers thereof partially peeled away to show the underlying layer.

### DETAILED DESCRIPTION

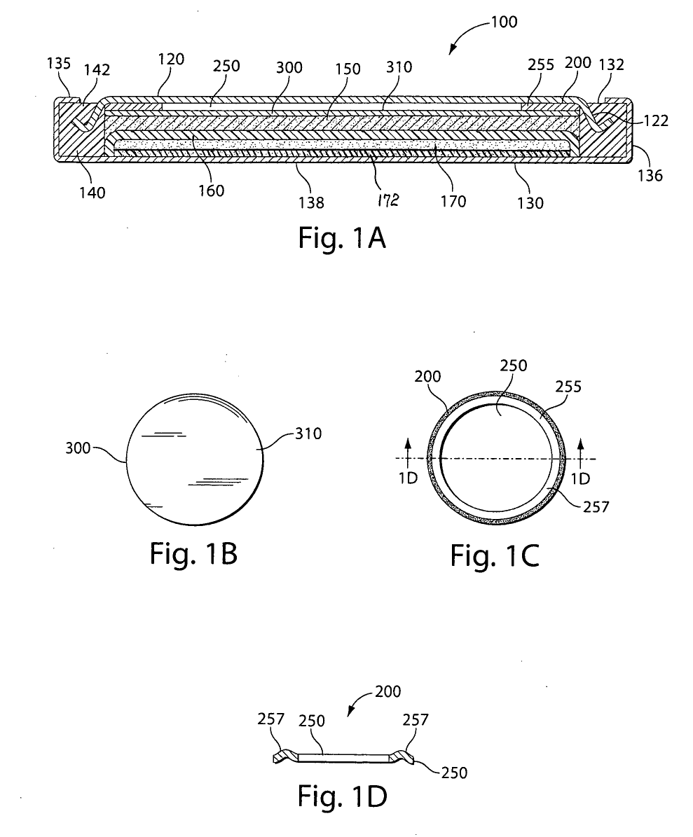

The Li/FeS₂ cell of the invention may be in the form of a flat button (coin) cell or a spirally wound cell. A desirable button cell 100 configuration comprising a lithium anode 150 and a cathode 170 comprising iron disulfide (FeS₂) with separator 160 therebetween is shown in the FIG. 1A.

The Li/FeS₂ cell as in cell 100 has the following basic discharge reactions (one step mechanism):

Anode:

4Li=4Li⁺+4e Eq. 1

Cathode:

FeS₂+4Li⁺+4e=Fe+2Li₂S Eq. 2

Overall:

FeS₂+4Li=Fe+2Li₂S Eq. 3

An embodiment of a Li/FeS₂ button (coin) cell 100 of the invention is shown in FIG. 1A. Cell 100 is a primary (nonrechargeable) cell. In the button cell 100 (FIG. 1A) a disk-shaped cylindrical cathode housing 130 is formed having an open end 132 and a closed end 138. Cathode housing 130 is preferably formed from nickel-plated steel. An electrical insulating member 140, preferably a plastic cylindrical member of disk shape having a hollow core, can be inserted into housing 130 so that the outside surface of insulating member 140 abuts and lines the inside surface of cathode housing 130 side walls 136. Alternatively, the inside surface of side walls 136 may be coated with a polymeric material that solidifies into insulator 140 abutting the inside surface of housing 130. Insulator 140 may first be fitted over the side walls 122 of the anode housing 120 before insertion into cathode housing 130. Insulator 140 can be formed from a variety of thermally stable insulating materials, but is preferably formed of polypropylene.

The cathode 170 comprising iron disulfide (FeS₂) powder dispersed therein, can be prepared in the form of a slurry which may be coated directly onto a conductive substrate sheet 172 which is desirably a sheet of aluminum, aluminum alloy, or stainless steel. Desirably the cathode 170 in the form of a slurry can be first coated on one side of the conductive substrate, then dried to form the final cathode 170. The finished cathode 170 can be stored in sheets until ready for insertion into the cell housing. The conductive sheet 172 onto which the cathode slurry 170 is coated may be a conductive sheet, such as a sheet of aluminum or aluminum alloy foil without any apertures therethrough. Alternatively, the conductive substrate 172 may be a sheet of stainless steel, aluminum or aluminum alloy, having a plurality of small apertures therein, thus forming a grid or screen. The cathode coating is dried to from a dry cathode 170 coated on one side of the substrate 172. The dried cathode 170 coated on substrate 172 can be subjected to calendering and stored in sheets until ready for insertion into the cell housing.

The cathode slurry comprises 2 to 4 wt % of binder (KRATON G1651 elastomeric binder from Kraton Polymers, Houston Tex.); 50 to 70 wt % of active FeS₂ powder; 4 to 7 wt % of conductive carbon (carbon black and graphite); and 25 to 40 wt % of solvent(s). (Carbon black may be made from the incomplete combustion or thermal decomposition of natural gas or petroleum oil. Carbon black may also be acetylene black which is made from the incomplete combustion or thermal decomposition of acetylene. Thus, the carbon black referenced herein, unless otherwise stated, may include in whole or in part acetylene black.) The KRATON G1651 binder is an elastomeric block copolymer (styrene-ethylene/butylene (SEBS) block copolymer) which is a film-former. This binder possesses sufficient affinity for the active FeS₂ and carbon black particles to facilitate preparation of the wet cathode slurry and to keep these particles in contact with each other after the solvents are evaporated. The FeS₂ powder may have an average particle size between about 1 and 100 micron, desirably between about 10 and 50 micron. A desirable FeS₂ powder is available under the trade designation PYROX Red 325 powder from Chemetall GmbH, wherein the FeS₂ powder has a particle size sufficiently small that most of particles will pass through a sieve of Tyler mesh size 325 (sieve openings of 0.045 mm). (The residue amount of FeS₂ particles not passing through the 325 mesh sieve is desirably 10% maximum.) A suitable graphite is available under the trade designation TIMREX KS6 graphite from Timcal Ltd. TIMREX graphite is a highly crystalline synthetic graphite. (Other graphites may be employed selected from natural, synthetic, or expanded graphite and mixtures thereof, but the TIMREX graphite is preferred because of its high purity.) The carbon black is available under the trade designation Super P conductive carbon black (acetylene black, BET surface of 62 m²/g) from Timcal Co.

The solvents use to form the wet cathode slurry preferably include a mixture of C₉-C₁₁ (predominately C₉) aromatic hydrocarbons available as SHELL SOL A100 hydrocarbon solvent (Shell Chemical Co.) and a mixture of primarily isoparaffins (average M.W. 166, aromatic content less than 0.25 wt. %) available as SHELL SOL OMS hydrocarbon solvent (Shell Chemical Co.). The weight ratio of SHELL SOL A100 to SHELL SOL OMS solvent is desirably at a 4:6 weight ratio. The SHELL SOL A100 solvent is a hydrocarbon mixture containing mostly aromatic hydrocarbons (over 90 wt % aromatic hydrocarbon), primarily C₉ to C₁₁ aromatic hydrocarbons. The SHELL SOL OMS solvent is a mixture of isoparaffin hydrocarbons (98 wt. % isoparaffins, M.W. about 166) with less than 0.25 wt % aromatic hydrocarbon content. The slurry formulation may be dispersed using a double planetary mixer. Dry powders are first blended to ensure uniformity before being added to the binder solution in the mixing bowl.

A preferred cathode slurry mixture is presented in Table 1:

TABLE I
Cathode Slurry

| | Wet Slurry | Dry Cathode |
|---|---|---|
| | (wt. %) | (wt. %) |
| Binder | 2.0 | 3.01 |
| (KRATON G1651) | | |
| Hydrocarbon Solvent | 13.4 | 0.0 |
| (SHELL SOL A100) | | |
| (SHELL SOL OMS) | 20.2 | 0.0 |
| FeS₂ Powder | 58.9 | 88.71 |
| (PYROX Red 325) | | |
| Graphite | 4.8 | 7.23 |
| (TIMREX KS6) | | |
| Carbon Black | 0.7 | 1.05 |
| (Super P) | | |
| Total | 100.0 | 100.0 |

This same or similar wet cathode slurry mixture (electrolyte not yet added to the cell) is disclosed in commonly assigned application Ser. No. 11/516,534 (US2008-0057403 A1). The total solids content of the wet cathode slurry mixture 170 is shown in above Table 1 is 66.4 wt. %

The wet cathode slurry 170 is coated onto at least one side of the above mentioned conductive substrate 172 desirably a sheet of stainless steel, aluminum or aluminum alloy. The conductive sheet may have perforations or apertures therein or may be a solid sheet without such perforations or apertures. The wet cathode slurry 170 may be coated onto the conductive substrate using intermittent roll coating technique. The cathode slurry coated on the conductive substrate is dried gradually adjusting or ramping up the temperature from an initial temperature of 40° C. to a final temperature of about 130° C. in an oven until the solvent has all evaporated. (Drying the cathode slurry in this manner avoids cracking.) This forms a dry cathode coating 170 comprising FeS₂, carbon particles, and binder on the conductive substrate. Optionally the opposite side of the conductive substrate may be coated with the same or similar wet cathode slurry 170. This second wet cathode coating 170 may likewise be dried in the same manner as the first coating. The coated cathode is then passed between calendering rolls to obtain the desired dry cathode thicknesses. If both sides of the conductive substrate is coated with cathode material, then the dried cathode 170 may typically have a final thickness of between about 0.170 and 0.186 mm, which includes the 20 micron thick conductive substrate, preferably aluminum foil. For purposes of producing a coin cell 100 (FIG. 1A) for use in experiments reported herein, only one side of an aluminum foil was coated with cathode slurry and dried to form dry cathode 170. The dried cathode coating on the aluminum sheet was calendered to form a dry cathode 170 having a total final thickness of about 0.096 mm, which includes the 20 micron thick aluminum foil. (The opposite side of the aluminum foil was not coated with cathode material.)

The dry cathode coating 170 thus has the following desirable formulation: FeS₂ powder (89 wt. %); Binder (KRATON G1651), 3 wt. %; Graphite (TIMREX KS6), 7 wt. %, and Carbon Black (Super P), 1 wt %. The carbon black (Super P carbon black) develops a carbon network which improves conductivity.

A durable dry cathode 170 sheet is thus formed in this manner. The cathode 170 sheet may be set aside until ready to be cut to proper size for insertion into the cell housing.

There can be variations in the sequence of assembling and loading the cell contents into the cell housing. However it has been determined that button cell 100 can be conveniently assembled in the following manner to form a completed cell suitable for use or testing:

Cell 100 can be formed conveniently by loading the anode housing 120, preferably of nickel plated steel, with all of the necessary cell components, including the electrolyte. Then the cathode housing 130, preferably of aluminum plated steel, can be inserted and crimped over the anode housing 120 to tightly close the cell. Thus, a durable cell 100, can be assembled by first inserting insulator disk 142, preferably of polypropylene, over the anode housing 120 so that it covers the side walls 122 of said housing 120 (FIG. 1A). Then spring ring 200 (FIG. 1C) can be inserted into the anode housing 120 so that it lies against the inside surface of the closed end of said housing as shown in FIG. 1A. Spring ring 200, preferably of stainless steel, has a central aperture 250 therethrough bounded by circumferential ring surface 255. Ring surface 255 is not flat but rather has integral convolutions 257 therein as shown in FIG. 1D. The convolutions 257 gives ring 200 a spring action when it is inserted in the anode housing 120 as pressure is applied to the ring. Next one or more spacer disks 300, preferably of stainless steel, can be inserted into anode housing 120 so that it presses onto spring ring 200 as shown in FIG. 1A. The spacer disks 300 can be solid flat disks as shown in FIG. 1B. A plurality of such spacer disks 300 can be employed to assure a tight fit of the cell contents within the completed cell. A lithium anode sheet 150, of lithium or lithium alloy metal, can then be inserted into the anode housing so that it lies against spacer disk 300 as shown in FIG. 1A. The anode housing can be inverted so that its open end is on top. Separator sheet 160, preferably of microporous polypropylene, can then be inserted against the lithium anode sheet 150.

The electrolyte solution of the invention, preferably comprising a mixture of lithium iodide (LiI) salt dissolved in a solvent mixture comprising 1,3-dioxolane (DX) and 1,3-dimethy-2-imidazolidinone (DID) can then be poured over the exposed surface of the separator sheet 160 so that it becomes absorbed into the separator. Cathode sheet 170 above described comprising the FeS₂ actives, can be cut to proper size and then inserted against the exposed side of the separator sheet 160. In this manner all of the cell components are inserted into the anode housing 120. The cathode housing 130 can then be inserted over the anode housing 120 so that the side wall 136 of the cathode housing 130 covers side wall 122 of anode housing 120 with insulator 140 therebetween. The edge 135 of the cathode housing 130 is crimped over the exposed insulator edge 142. The edge 135 bites into the insulator edge 142 to close the cell and tightly seal the cell contents therein. This results in a durable button cell 100 which resists electrolyte leakage.

A preferred electrolyte mixture of the invention for the lithium/iron disulfide cell has been determined to be a blend comprising lithium iodide (LiI) dissolved in a mixture of 1,3-dioxolane (DX) and 1,3-dimethyl-2-imidazolidinone (DID), wherein the 1,3-dioxolane (DX) comprises between about 70 and 90 percent by volume and the 1,3-dimethyl-2-imidazolidinone (DID) comprises between about 10 and 30 percent by volume of the solvent mixture. The lithium iodide is dissolved in the solvent mixture forming the electrolyte. The lithium iodide desirably is present in said solvent mixture in a concentration of between about 0.5 and 1.2 mols per liter of solvent mixture, preferably about 0.8 mols per liter.

A solvent additive (third solvent) may be added in small amount to the above preferred electrolyte in order to retard the rate of polymerization of the 1,3-dioxolane. The solvent additive may be selected from pyridine, an alkylisoxazole, such as 3,5-dimethylisoxazole (DMI) (C₅H₇NO), an alkylpryrazole, preferably 1,3,5-trimethylpyrazole (TMP) (C₆H₁₀N₂) or an alkylimidazole, preferably 1,2-dimethyimidazole (DI) (C₅H₈N₂). Such solvent additive to the electrolyte for the Li/FeS₂ cell in addition to retarding the rate of dioxolane polymerization, also appears to retard the rate of buildup of a deleterious passivation layer on the surface of the lithium anode. The solvent additive may comprise between about 0.2 and 5.0 percent by volume, typically between about 0.2 and 1.0 percent by volume of the total solvent mixture. The electrolyte does not noticeably react with or degrade the lithium anode or cathode components which includes FeS₂, conductive carbon and binder.

The electrolyte formed of the lithium salt dissolved in the above described solvents has a very desirable viscosity of between about 0.9 and 1.4 centipoise, typically about 1.2 and 1.4 centipoise. Such low viscosity for the electrolyte reduces the chance of lithium ion (Li+) concentration polarization and improves lithium ionic mobility and transport of the lithium ions from anode to cathode. This improves the Li/FeS₂ cell performance even when the cell is discharged at elevated pulsed current rate needed to power digital cameras. Additionally, the electrolyte solution of the invention as applied to the Li/FeS₂ cell does not appear to exacerbate the problem of lithium anode passivation. Lithium anode passivation is a problem associated with essentially all electrochemical cells having a lithium metal anode. During cell discharge or storage a coating gradually forms on the surface of the lithium anode which can interfere with efficient cell performance and reduce capacity. The electrolyte formulation of the invention comprising 1,3-dioxolane and 1,3-dimethyl-2-imidazolidinone (DID) does not require the addition of any acyclic (non cyclic) ether such as dimethoxyethane (DME), ethyl glyme, or diglyme or triglyme.

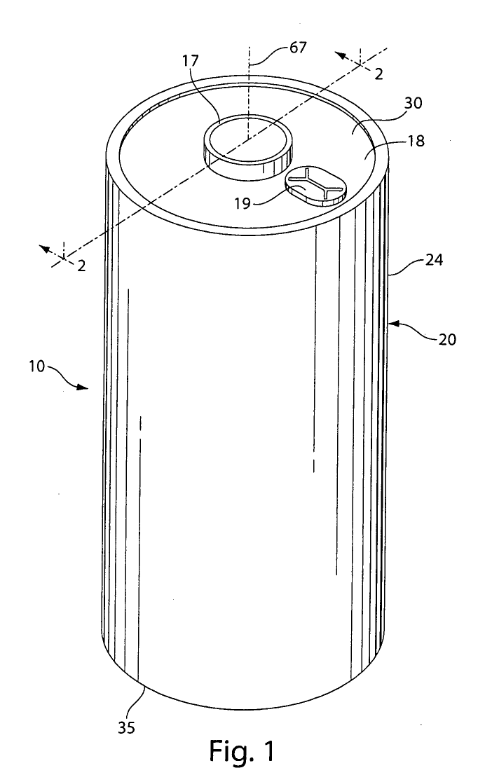

In another embodiment the Li/FeS₂ cell may be in the configuration of a cylindrical cell 10 as shown in FIG. 1. The cylindrical cell 10 may have a spirally wound anode sheet 40, cathode 60 with separator sheet 50 therebetween as shown in FIGS. 2-5. The Li/FeS₂ cell 10 internal configuration, apart from the difference in cathode composition, may be similar to the spirally wound configuration shown and described in U.S. Pat. No. 6,443,999. The anode sheet 40 as shown in the figures comprises lithium metal and the cathode sheet 60 comprises iron disulfide (FeS₂) commonly known as “pyrite”. The cell is preferably cylindrical as shown in the figures and may be of any size, for example, AAAA (42×8mm), AAA (44×9 mm), AA (49×12 mm), C (49×25 mm) and D (58×32 mm) size. Thus, cell 10 depicted in FIG. 1 may also be a 2/3 A cell (35×15mm). However, it is not intended to limit the cell configuration to cylindrical shape. Alternatively, the cell of the invention may have an anode comprising lithium metal and a cathode comprising iron disulfide (FeS₂) having the composition and electrolyte as herein described in the form of a spirally wound prismatic cell, for example a rectangular cell having the overall shape of a cuboid.

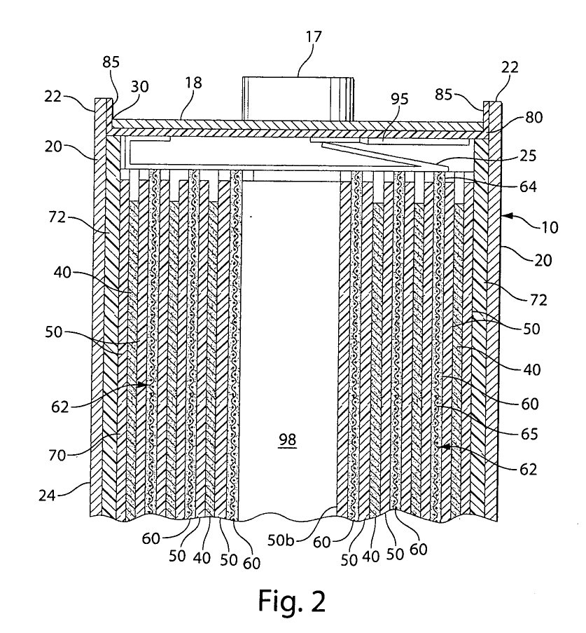

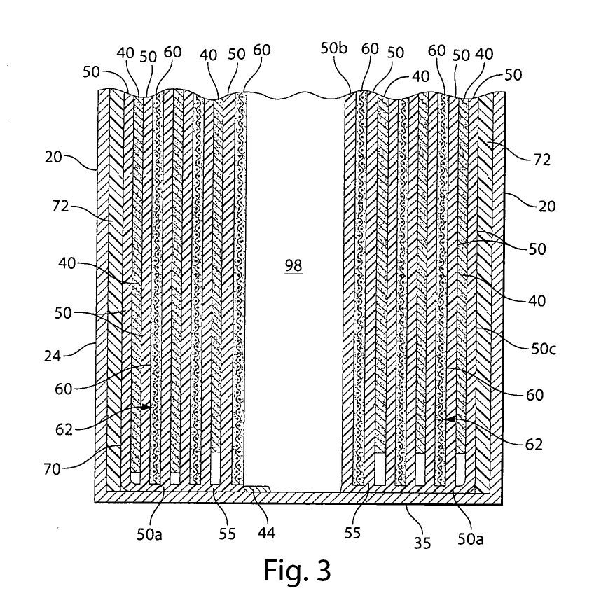

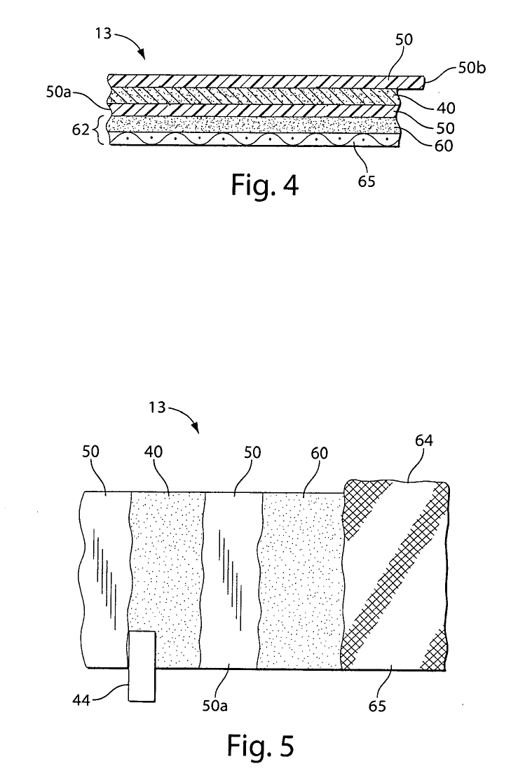

For a spirally wound cell, a preferred shape of the cell casing (housing) 20 is cylindrical as shown in FIG. 1. A similar wound cell structural configuration for the Li/FeS₂ cell is also shown and described in commonly assigned patent application Ser. No. 11/516534 (US2008-0057403 A1). Casing 20 is preferably formed of nickel plated steel. The cell casing 20 (FIG. 1) has a continuous cylindrical surface. The spiral wound electrode assembly 70 (FIG. 3) comprising anode 40 and cathode composite 62 with separator 50 therebetween can be prepared by spirally winding a flat electrode composite 13 (FIGS. 4 and 5). Cathode composite 62 comprises a layer of cathode 60 comprising iron disulfide (FeS₂) coated onto metallic substrate 65 (FIG. 4).

The electrode composite 13 (FIGS. 4 and 5) can be made in the following manner: The cathode 60 comprising iron disulfide (FeS₂) powder dispersed therein can be initially prepared in the form of a wet slurry which is coated onto a conductive substrate sheet or metal foil 65. The conductive substrate 65 may be a sheet of aluminum or stainless steel, for example, expanded metal foil of aluminum or stainless steel (FIG. 4). If an aluminum sheet 65 is used it may be a solid sheet of aluminum without openings therethrough or may be a sheet of expanded aluminum foil (EXMET expanded aluminum foil) with openings therethrough thus forming a grid or screen. (EXMET aluminum or stainless steel foil from Dexmet Company, Branford, Conn.). The apertures in conductive substrate sheet 65 may also be the result of punching or piercing holes therein. The expanded metal foil may have a basis weight of about 0.024 g/cm² forming a mesh or screen with openings therein. Typically the aluminum sheet 65 may have a thickness between about 0.015 and 0.040 mm.

The wet cathode slurry mixture having the composition shown above in Table 1 comprising iron disulfide (FeS₂), binder, conductive carbon and solvents is prepared by mixing the components shown in Table 1 until a homogeneous mixture is obtained.

The above quantities (Table 1) of components of course can be scaled proportionally so that small or large batches of cathode slurry can be prepared. The wet cathode slurry thus preferably has the following composition: FeS₂ powder (58.9 wt. %); Binder, KRATON G1651 (2 wt. %); Graphite, TIMREX KS6 (4.8 wt %), Actylene Black, Super P (0.7 wt %), Hydrocarbon Solvents, SHELL SOL A100 (13.4 wt %) and ShelSol OMS (20.2 wt %)

The cathode slurry is coated onto at least one side of a conductive substrate or grid 65, preferably a sheet of aluminum, or stainless steel expanded metal foil. The cathode slurry coated on the metal substrate 65 is dried in an oven preferably gradually adjusting or ramping up the temperature from an initial temperature of 40° C. to a final temperature not to exceed 130° C. for about ½ hour or until the solvent has all evaporated. This forms a dry cathode coating 60 comprising FeS₂, carbon particles, and binder on the metal substrate 65 and thus forms the cathode composite sheet 62 shown best in FIG. 4. A calendering roller is then applied to the coating to obtain the desired cathode thicknesses. Optionally, the cathode slurry may then also be coated onto the opposite side of the same conductive substrate 65. The cathode slurry coating on the opposite side of substrate 65 is then dried in the same manner as above describe, followed by calendering the dried coating. This results in a cathode composite sheet 62 with dry cathode coating 60 coated on both sides of metal substrate 65. For an AA size Li/FeS₂ cell, the desired thickness of the dry/ cathode composite 62 is between about 0.172 and 0.188 mm, preferably between about 0.176 and 0.180 mm, with a cathode coating 60 coated on both sides of aluminum substrate 65. This includes the substrate 65, preferably of aluminum foil, having a thickness of between about 0.015 and 0.040 mm. The dry cathode coating 60 thus has the following desirable formulation: FeS₂ powder (89.0 wt. %); binder, KRATON G1651 elastomer (3.0 wt. %); conductive carbon particles, preferably graphite (7 wt. %) available as TIMREX KS6 graphite from Timcal Ltd and conductive carbon black (1 wt %) available as Super P conductive carbon black from Timcal. The carbon black develops a carbon network which improves conductivity. Optionally between about 0 and 90 percent by weight of the total carbon particles may be graphite. The graphite if added may be natural, synthetic or expanded graphite and mixtures thereof. The dry cathode coating may typically comprise between about 85 and 95 wt. % iron disulfide (FeS₂); between about 4 and 8 wt. % conductive carbon; and the remainder of said dry coating comprising binder material.

The anode 40 can be prepared from a solid sheet of lithium metal. The anode 40 is desirably formed of a continuous sheet of lithium metal (99.8% pure). Alternatively, the anode 40 can be an alloy of lithium and an alloy metal, for example, an alloy of lithium and aluminum. In such case the alloy metal, is present in very small quantity, preferably less than 1 or 2 percent by weight of the lithium alloy. Upon cell discharge the lithium in the alloy thus functions electrochemically essentially as pure lithium. Thus, the term “lithium or lithium metal” as used herein and in the claims is intended to include in its meaning such lithium alloy. The lithium sheet forming anode 40 does not require a substrate. The lithium anode 40 can be advantageously formed from an extruded sheet of lithium metal having a thickness of desirably between about 0.10 and 0.20 mm desirably between about 0.12 and 0.19 mm, preferably about 0.15 mm for the spirally wound cell.

Individual sheets of electrolyte permeable separator material 50, preferably of microporous polypropylene having a thickness of about 0.025 mm or less, preferably between about 0.008 and 0.025 mm, is inserted on each side of the lithium anode sheet 40 (FIGS. 4 and 5). The microporous polypropylene desirably has a pore size between about 0.001 and 5 micron. The first (top) separator sheet 50 (FIG. 4) can be designated the outer separator sheet and the second sheet 50 (FIG. 4) can be designated the inner separator sheet. The cathode composite sheet 62 comprising cathode coating 60 on conductive substrate 65 is then placed against the inner separator sheet 50 to form the flat electrode composite 13 shown in FIG. 4. The flat composite 13 (FIG. 4) is spirally wound to form electrode spiral assembly 70 (FIG. 3). The winding can be accomplished using a mandrel to grip an extended separator edge 50b (FIG. 4) of electrode composite 13 and then spirally winding composite 13 clockwise to form wound electrode assembly 70 (FIG. 3).

When the winding is completed separator portion 50b appears within the core 98 of the wound electrode assembly 70 as shown in FIGS. 2 and 3. By way of non limiting example, the bottom edges 50a of each revolution of the separator may be heat formed into a continuous membrane 55 as shown in FIG. 3 and taught in U.S. Pat. No. 6,443,999. As may be seen from FIG. 3 the electrode spiral 70 has separator material 50 between anode sheet 40 and cathode composite 62. The spirally wound electrode assembly 70 has a configuration (FIG. 3) conforming to the shape of the casing body. The spirally wound electrode assembly 70 is inserted into the open end 30 of casing 20. As wound, the outer layer of the electrode spiral 70 comprises separator material 50 shown in FIGS. 2 and 3. An additional insulating layer 72, for example, a plastic film such as polpropylene tape, can desirably be placed over a of the outer separator layer 50, before the electrode composite 13 is wound. In such case the spirally wound electrode 70 will have insulating layer 72 in contact with the inside surface of casing 20 (FIGS. 2 and 3) when the wound electrode composite is inserted into the casing. Alternatively, the inside surface of the casing 20 can be coated with electrically insulating material 72 before the wound electrode spiral 70 is inserted into the casing.

The electrolyte mixture of the invention can then be added to the wound electrode spiral 70 after it is inserted into the cell casing 20. A desirable electrolyte of the invention as above described comprises about 0.8 molar (0.8 mol/liter) concentration of the lithium iodide (LiI) salt dissolved in a mixture of 1,3-dioxolane (DX) and 1,3-dimethyl-2-imidazolidinone (DID), wherein the 1,3-dioxolane (DX) comprises between about 70 and 90 percent by volume and the 1,3-dimethyl-2-imidazolidinone (DID) comprises between about 10 and 30 percent by volume of the solvent mixture. As above described the electrolyte of the invention may also include between about 0.2 and 5.0 vol %, preferably between about 0.2 and 1.0 vol %, of a solvent additive to retard dioxolane polymerization. A preferred solvent additive is alkylpryrazole, preferably l,3,5-trimethylpyrazole (TMP) or an alkylimidazole, preferably 1,2-dimethyimidazole (DI). The solvent additive may also be selected from pyridine or 3,5-dimethylisoxazole (DMI). The electrolyte of the invention is normally added to the wound electrode spiral 70 after electrode spiral 70 has been inserted within casing 20.

An end cap 18 forming the cell's positive terminal 17 may have a metal tab 25 (cathode tab) which can be welded on one of its sides to inside surface of end cap 18. Metal tab 25 is preferably of aluminum or aluminum alloy. A portion of the cathode substrate 65 forms an extended portion 64 extending from the top of the wound spiral as shown in FIG. 2. The extended portion 64 can be welded to the exposed side of metal tab 25 before the casing peripheral edge 22 is crimped around the end cap 18 with peripheral edge 85 of insulating disk 80 therebetween to close the cell's open end 30. End cap 18 desirably has a vent 19 which can contain a rupturable membrane designed to rupture and allow gas to escape if the gas pressure within the cell exceeds a predetermined level. Positive terminal 17 is desirably an integral portion of end cap 18. Alternatively, terminal 17 can be formed as the top of an end cap assembly of the type described in U.S. Pat. No. 5,879,832, which assembly can be inserted into an opening in the surface of end cap 18 and then welded thereto.

A metal tab 44 (anode tab), preferably of nickel can be pressed into a portion of the lithium metal anode 40. Anode tab 44 can be pressed into the lithium metal at any point within the spiral, for example, it can be pressed into the lithium metal at the outermost layer of the spiral as shown in FIG. 5. Anode tab 44 can be embossed on one side forming a plurality of raised portions on the side of the tab to be pressed into the lithium. The opposite side of tab 44 can be welded to the inside surface of the casing either to the inside surface of the casing side wall 24 or more preferably to the inside surface of close end 35 of casing 20 as shown in FIG. 3. It is preferable to weld anode tab 44 to the inside surface of the casing closed end 35, since this is readily accomplished by inserting an electrical spot welding probe (an elongated resistance welding electrode) into the cell core 98. Care should be taken to avoid contacting the welding probe to the separator starter tab 50b which is present along a portion of the outer boundary of cell core 98.

The primary lithium cell 10 may optionally also be provided with a PTC (positive thermal coefficient) device 95 located under the end cap 18 and connected in series between the cathode 60 and end cap 18 (FIG. 2). Such device protects the cell from discharge at a current drain higher than a predetermined level. Thus, if the cell is drained at an abnormally high current, e.g., higher than about 6 to 8 Amp, for a prolonged period, the resistance of the PTC device increases dramatically, thus shutting down the abnormally high drain. It will be appreciated that devices other than vent 19 and PTC device 95 may be employed to protect the cell from abusive use or discharge.

### EXAMPLE

### Comparative and Experimental Test Lithium Coin Cells with Cathode Comprising FeS₂

The Comparative and Experimental Test Li/FeS₂ coin cells 100 (FIG. 1A) were prepared as follows:

### Comparative and Experimental Test Coin Cell Assembly:

A coin shaped cathode housing 130 of aluminum plated steel and a coin shaped anode housing 120 of nickel plated steel is formed of a similar configuration shown in FIG. 1A. The finished cell 100 had an overall diameter of about 20 mm and a thickness of about 3 mm. (This is the size of a conventional ASTM size 2032 coin cell.) The weight of FeS₂ in the cathode housing 130 was 0.0232 g. The lithium in the anode housing 120 was in electrochemical excess.

In forming each cell 100 a plastic insulating of ring shape 140 was first fitted around the side wall 122 of anode housing 120 (FIG. 1A). A spring ring 200 of stainless steel was placed against the inside surface of the anode housing 120. Ring 200 is inserted into anode housing 120 without the need to weld the ring to the anode housing 120. Ring 200, shown best in FIG. 1C, has a circumferential edge 255 bounding central aperture 250. Circumferential edge surface 255 has convolutions 257 (FIG. 1D) integrally formed therein so that edge surface 255 does not lie entirely in the same plane. When spring ring 200 is inserted into anode housing 120 and pressure is applied to the edge surface 255, convolutions 257 therein give the ring resilience and a spring effect. A spacer disk 300 having a flat solid surface 310 is then next inserted into the anode housing 120 so that it lies against spring ring 200 (FIG. 1A). More than one spacer disk 300 may be inserted on top of each other in stacked arrangement in order to provide a tight fit of the cell contents within the cell. In the test coin cell 100 three stainless steel spacer disks 300 were applied in stacked arrangement against spring ring 200.

A lithium disk 150 formed of a sheet of lithium metal having a thickness of 0.006 inch (0.15 mm) was punched out in a dry room using a 0.56 inch hand punch. The lithium disk 150 (FIG. 1A) forming the cell's anode was then pressed onto the underside of the spacer disks 300 using a hand press.

A cathode slurry was then prepared and coated over one side of an aluminum sheet 172. The components of the cathode slurry comprising iron disulfide (FeS₂) were mixed together in the following proportion:

FeS₂ powder (58.9 wt. %); Binder, styrene-ethylene/butylene-styrene elastomer (KRATON G1651) (2 wt. %); Graphite (TIMREX KS6) (4.8 wt %), Carbon Black (Super P carbon black) (0.7 wt %), Hydrocarbon Solvents, SHELL SOL A100 solvent (13.4 wt %) and SHELL SOL OMS solvent (20.2 wt %).

The wet cathode slurry on the aluminum sheet 172 was then dried in an oven between 40° C. and 130° C. until the solvent in the cathode slurry all evaporated, thus forming a dry cathode coating comprising FeS₂, conductive carbon and elastomeric binder coated on a side of the aluminum sheet. The aluminum sheet 172 was an aluminum foil of 20 micron thickness. The dried cathode coating 170 on the aluminum sheet 172 was calendered to form a dry cathode 170 having a total final thickness of about 0.096 mm, which includes the 20 micron thick aluminum foil. (The opposite side of the aluminum sheet 172 was not coated with cathode material.)

The anode housing 120 is inverted so that its open end faces up. Separator disk 160 is inserted into the anode housing 120 so that it contacts the lithium anode disk 150. Separator disk 160 was of microporous polypropylene (Celgard CG2500 separator from Celgard, Inc.) The separator disk was previously punched out from sheets into the required disk shape using a hand punch having a diameter of 0.69 inch (17.5 mm).

Groups I, II, III, and IV of identical cells were made as above described except that different electrolytes were prepared as summarized below and in Table II. Group I cells used a comparative electrolyte and the remaining Groups used the electrolyte of the invention described in more detail below. With the anode housing 120 inverted with the open end on top, 0.2 g of the electrolyte solution was added over separator 160.

The dried cathode 170 was cut to size in disk shape with a hand punch having a diameter of 0.44 inch (11.1 mm) and inserted into the anode housing 120 so that it contacts the electrolyte soaked separator 160. The cathode 170 with dried cathode coating on one side of the aluminum sheet 172 faces separator 160, thus forming the anode/cathode interfacial area. The opposite side of the aluminum sheet 172 (not coated) contacts the closed end 138 of housing 130. The amount of FeS₂ in the dried cathode 170 for each cell was identical. The amount of FeS₂ which is subject to electrochemical discharge is about 0.0232 g. The dry cathode coating 170 for each cell had the following composition:

FeS₂ powder (89.0 wt. %); Binder KRATON G1651 elastomer (3.0 wt. %); conductive carbon particles, graphite TIMREX KS6 (7 wt. %) and carbon acetylene black, Super P (1 wt %).

The cathode housing 130 was then placed over the filled anode housing 120 so that the side wall 136 of the cathode housing 130 covered side wall 122 of anode housing 120 with insulator 140 therebetween. The closed end 138 of the cathode housing 130 was centered within a mechanical crimper. A mechanical crimper arm was then pulled down all of the way to crimp the peripheral edge 135 of the cathode housing 130 over the edge 142 of insulating disk 140. This process was repeated for each cell, thus forming the completed coin cell 100 shown in FIG. 1A. After each cell had been formed, the outside surfaces of the housings of the cells were wiped cleaned with methanol.

### Electrochemical Performance of Comparative and Experimental Test Cells:

After fresh cells had been formed as above described, the discharge capacity of each cell was tested using a test that was meant to mimic the use of the cell in a digital camera (DIGICAM Test). Before the DIGICAM test was applied, however, all the fresh cells were first predischarged to consume 3 percent of the cell's capacity. Immediately after predischarge some of the fresh cells from each group were subjected directly to the DIGICAM test. Other fresh cells from each group were all stored at 60° C. for 20 days and these stored cells were then subjected to the DIGICAM test. The DIGICAM test protocol is as follows:

The digital camera test (DIGICAM test) consists of the following pulse test protocol wherein each test cell was drained by applying pulsed discharge cycles to the cell: Each cycle consists of both a 6.5 milliwatt pulse for 2 seconds followed immediately by a 2.82 milliwatt pulse for 28 seconds. (This is intended to mimic the power of the digital camera required to take a picture and view the picture taken.) The cycles are continued until a cutoff voltage of 1.05V is reached and then the cycles continued until a final cutoff voltage of 0.9 volt is reached. The number of cycles required to reach these cutoff voltages were recorded.

Four groups of identical Li/FeS₂ coin test cells (ASTM size 2032) were made as above described, but each group of cells had a different electrolyte. The Group I cells was the comparative group utilizing the electrolyte Li(CF₃SO₂)₂N (LiTFSI) dissolved a solvent mixture comprising 1,3-dioxolane (DX) and sulfolane (SL) of the type electrolyte disclosed in International Application WO2008/012776 A2. The Groups II, III, and IV cells were the experimental test cells utilizing the electrolyte of the invention comprising lithium iodide dissolved in a solvent mixture comprising 1,3-dioxolane (DX) and 1,3-dimethyl-2-imidazolidinone (DID). The specific electrolyte used in each group of cells is given as follows:

### Group I (Comparative)

Electrolyte: Lithium bistrifluoromethylsulfonyl imide, Li(CF₃SO₂)₂N (LiTFSI), 0.8 mols/liter, dissolved in a solvent mixture of 1,3-dioxolane (DX) and sulfolane (SL) at volume ratio 80:20, with 0.2 vol % pyridine added.

### Group II (Test Cells)

Electrolyte: Lithium iodide (LiI), 0.8 mols/liter, dissolved in a solvent mixture of 1,3-dioxolane (DX) and 1,3-dimethyl-2-imidazolidinone (DID) at volume ratio of 80:20, with 0.2 vol % of 3,5-dimethylisoxazole (DMI) added.

### Group III (Test Cells)

Electrolyte: Lithium iodide (LiI), 0.8 mols/liter, dissolved in a solvent mixture of 1,3-dioxolane (DX), 80 vol %, and 1,3-dimethyl-2-imidazolidinone (DID), 15 vol %, with solvent additive 1,3,5-trimethylpyrazole (TMP), 5 vol %.

### Group IV (Test Cells)

Electrolyte: Lithium iodide (LiI), 0.8 mols/liter, dissolved in a solvent mixture of 1,3-dioxolane (DX), 80 vol %, and 1,3-dimethyl-2-imidazolidinone (DID), 15 vol %, with solvent additive 1,2-dimethylimidazole (DI), 5 vol %.

The cells were discharged in the above described DIGICAM Test. The results are reported in Table II.

TABLE II
Discharge Performance of Li/FeS₂ Coin Cells With
Electrolyte Formulation of the Invention

| | | DIGICAM Number of Pulsed Cycles¹ | | | |
|---|---|---|---|---|---|
| | | Fresh Cell² | | Stored Cells³ | |
| Cell Group | Cell No. | 1.05 V | 0.90 V | 1.05 V | 0.90 V |
| Comparative (I) | 1 | 461 | 641 | 541 | 670 |
| Comparative (I) | 2 | 521 | 631 | 560 | 669 |
| Comparative (I) | 3 | 541 | 671 | 558 | 665 |
| | Average | 508 | 648 | 553 | 668 |
| Test Cell (II) | 1 | 671 | 730 | 521 | 681 |
| Test Cell (II) | 2 | 591 | 691 | 551 | 693 |
| Test Cell (II) | 3 | 671 | 730 | 561 | 700 |
| | Average | 644 | 717 | 544 | 691 |
| Test Cell (III) | 1 | 641 | 720 | 461 | 621 |
| Test Cell (III) | 2 | 621 | 710 | 551 | 671 |
| Test Cell (III) | 3 | 641 | 711 | 461 | 620 |
| | Average | 634 | 714 | 491 | 637 |
| Test Cell (IV) | 1 | 571 | 671 | 441 | 561 |
| Test Cell (IV) | 2 | 501 | 591 | 430 | 651 |
| Test Cell (IV) | 3 | 551 | 671 | 431 | 601 |
| | Average | 541 | 644 | 434 | 604 |

Notes:
¹DIGICAM Test: Each cycle consists of both a 6.5 milliWatt pulse for 2 seconds followed immediately by a 2.82 milliWatt pulse for 28 seconds to mimic use in a digital camera. Number of pulsed cycles reported until cutoff voltage of 1.05 V and 0.90 V were reached.
²The fresh cells were predischarged consuming 3 percent of cell capacity and then subjected to the DIGICAM test.
³The cells were predischarged consuming 3 percent of cell capacity. The cells were then stored at 60° C. for 20 days and then subjected to the DIGICAM test.

The above reported test results (Table II) indicate very good Li/FeS₂ cell performance with the electrolyte of the invention (Groups II, III, and IV). The above test results indicate that the fresh test cells from Groups II, III, and IV performed better than the comparable cells (Group I) when discharged to a cut off voltage of about 1.05V. When the fresh cells were discharged to a cut off voltage of about 0.90V, the Group II and III test cells performed better than the Group I comparative cells and the Group IV test cells performed about the same as the Group I comparative cells. When the stored cells were discharged to a cut off voltage of 0.90V, the Group II test cells performed better than the Group I comparative cells. The test cells did not exhibit any leakage either during storage or discharge.

The electrolyte of the invention resulted in a Li/FeS₂ cell with very good performance, but had the advantage that it was a less expensive electrolyte than the comparative electrolyte.

Although the invention has been described with reference to specific embodiments, it should be appreciated that other embodiments are possible without departing from the concept of the invention and are thus within the claims and equivalents thereof.

1. A primary electrochemical cell comprising a housing; a positive and a negative terminal; an anode comprising at least one of a lithium metal and lithium alloy; a cathode comprising iron disulfide (FeS₂) and conductive carbon; said cell further comprising an electrolyte comprising a lithium salt comprising lithium iodide dissolved in a solvent mixture comprising the cyclic diether 1,3-dioxolane and a cyclic compound selected from the group consisting of 1,3-dimethyl-2-imidazolidinone, 1,3-diethyl-2-imidazolidinone, and 1,3-dipropyl-2-imidazolidinone.

2. The cell of claim 1 wherein said cyclic compound comprises 1,3-dimethyl-2-imidazolidinone.

3. The cell of claim 1 wherein said solvent mixture comprises between about 70 and 90 percent by volume 1,3-dioxolane and between about 10 and 30 percent by volume 1,3-dimethyl-2-imidazolidinone.

4. The cell of claim 1 wherein the lithium iodide is present in said solvent mixture in a concentration of between about 0.5 and 1.2 moles per liter.

5. The cell of claim 1 wherein said solvent mixture further comprises between about 0.2 and 5 percent by volume 1,2-dimethylimidazole.

6. The cell of claim 1 wherein said solvent mixture further comprises between about 0.2 and 5 percent by volume 1,3,5-trimethylpyrazole.

7. The cell of claim 1 wherein said solvent mixture further comprises between about 0.2 and 5 percent by volume pyridine.

8. The cell of claim 1 wherein said solvent mixture further comprises between about 0.2 and 5 percent by volume 3,5-dimethylisoxazole.

9. The cell of claim 1 wherein said electrolyte has a low viscosity of between about 0.9 and 1.4 centipoise.

10. The cell of claim 1 wherein said electrolyte has a low viscosity of between about 1.2 and 1.4 centipoise.

11. The cell of claim 1 wherein said electrolyte has a conductivity between about 8 and 11 milliSiemens per centimeter.

12. The cell of claim 1 wherein said cathode comprising iron disulfide (FeS₂) and conductive carbon is coated onto a substrate sheet comprising aluminum.

13. The cell of claim 1 wherein said conductive carbon comprises a mixture of carbon black and graphite.

14. The cell of claim 1 wherein said anode is in the form of a sheet.

15. The cell of claim 1 wherein said cathode comprising iron disulfide (FeS₂) is in the form of a coating bound to a metallic substrate; wherein said anode and said cathode are arranged in spirally wound form with a separator material therebetween.

16. The cell of claim 15 wherein said separator comprises microporous polypropylene.

17. A primary electrochemical cell comprising a housing; a positive and a negative terminal; an anode comprising at least one of a lithium metal and lithium alloy; a cathode comprising iron disulfide (FeS₂) and conductive carbon; said cell further comprising an electrolyte comprising a lithium salt comprising lithium iodide dissolved in a solvent mixture comprising the cyclic diether 1,3-dioxolane and cyclic compound 1,3-dimethyl-2-imidazolidinone.

18. The cell of claim 17 wherein said solvent mixture comprises between about 70 and 90 percent by volume 1,3-dioxolane and between about 10 and 30 percent by volume 1,3-dimethyl-2-imidazolidinone.

19. The cell of claim 17 wherein the lithium iodide is present in said solvent mixture in a concentration of between about 0.5 and 1.2 moles per liter.

20. The cell of claim 17 wherein said solvent mixture further comprises between about 0.2 and 5 percent by volume 1,2-dimethylimidazole.

21. The cell of claim 17 wherein said solvent mixture further comprises between about 0.2 and 5 percent by volume 1,3,5-trimethylpyrazole.

22. The cell of claim 17 wherein said solvent mixture further comprises between about 0.2 and 5 percent by volume pyridine.

23. The cell of claim 17 wherein said solvent mixture further comprises between about 0.2 and 5 percent by volume 3,5-dimethylisoxazole.

24. The cell of claim 17 wherein said electrolyte has a low viscosity of between about 0.9 and 1.4 centipoise.

25. The cell of claim 17 wherein said electrolyte has a low viscosity of between about 1.2 and 1.4 centipoise.

26. The cell of claim 17 wherein said electrolyte has a conductivity between about 8 and 11 milliSiemens per centimeter.

27. The cell of claim 17 wherein said cathode comprising iron disulfide (FeS₂) and conductive carbon is coated onto a substrate sheet comprising aluminum.

28. The cell of claim 17 wherein said conductive carbon comprises a mixture of carbon black and graphite.

29. The cell of claim 17 wherein said anode is in the form of a sheet.

30. The cell of claim 17 wherein said cathode comprising iron disulfide (FeS₂) is in the form of a coating bound to a metallic substrate; wherein said anode and said cathode are arranged in spirally wound form with a separator material therebetween.

31. The cell of claim 30 wherein said separator comprises microporous polypropylene.
